(19) United States
(12) Patent Application Publication
(10) Pub. No.: US 2003/0209945 A1
(43) Pub. Date: Nov. 13, 2003

(54) Cross ventilation technique for cooling redundant power supplies

(76) Inventor: George E. Hanson, Andover, KS (US)

Correspondence Address: LSI LOGIC CORPORATION, 1621 BARBER LANE, MS: D-106 LEGAL, MILPITAS, CA, 95035, US

(21) Appl. No.: 10/141,480

(22) Filed: May 7, 2002

(51) Int. Cl. H02J 1/00

(52) U.S. Cl. 307/149

(57) ABSTRACT

Disclosed is a cross ventilation technique for systems with redundant power supplies. Such systems may be fault tolerant, continuous uptime systems wherein a failed power supply may be replace while a system is running to ensure 100% uptime. The cross ventilation technique allows fans of a properly functioning power supply to aid in the ventilation of a neighboring power supply with a failed fan. The technique may allow a power supply with a failed fan to be functional for sufficient time such that an operator may replace the failed unit and restore the system to normal functionality. Further disclosed are methods for detection of failures and operation of the system in a degraded mode while awaiting service.

### BACKGROUND OF THE INVENTION

a. Field of the Invention

The present invention pertains generally to the cooling of power supplies and specifically to cooling power supplies in a redundant environment.

b. Description of the Background

High reliability systems for computing environments are becoming more and more necessary in today's computing intensive world. A short downtime by a computer server or telecommunications hub may have huge costs in lost revenue and inconvenience to customers. One application of the need for high reliability systems is in large disk arrays used for storing and retrieving large amounts of data. Redundant Arrays of Independent Disks (RAID) systems are capable of handling enormous amounts of data quickly and with a high degree of redundancy.

RAID systems may have the ability to tolerate a complete failure of one of the disk drives in the array and rebuild the data that was on the array onto a new drive. The failed drive may be removed and replaced with a new drive while the system is fully operational. The system may reconstruct the data that was on the failed drive by piecing the data back onto the new drive.

Such hot swapping concepts and fault tolerant designs are all predicated on the ability to have a consistent power supply. Redundant and replaceable power supplies for such a system is imperative in the event that a component may fail during use. In many cases, multiple power supplies and redundant components are built into the design to increase reliability.

For example, it is common to have duplicate components on a power supply, especially when the components are prone to failure. Fans are one of the most likely components to fail in a power supply. Fans are mechanical components that generate heat and friction and have an inherent life span. Further, fans have become high volume commodities that are normally purchased largely on price, with the end result that reliability and quality are often secondary features.

Duplicate fans in a power supply have been used for reliability reasons in various designs. If one fan fails, the other fan may be sufficient to keep the power supply operational for a certain period of time until the fan may be replaced. The system may have the ability to detect a failed fan, or the degraded performance of the power supply may indicate to an operator that service of the power supply is required. In either event, the power supply may function for a period of time allowing the service to be performed before the catastrophic shutdown of the system occurs.

Multiple power supplies in a system may be designed so that either power supply may be used independently to power the entire system. When one power supply is removed, the other power supply may have enough capacity to drive the system. In this manner, service may be performed while the system is fully operational.

A difficulty with constant uptime systems is the ability to detect a power supply problem and then have enough time to repair the problem before the power supply fails completely. After a fan failure in a power supply, there can be precious few minutes before the power supply fails completely. Premature detection of a problem leads to the repair and replacement of components that would otherwise function properly for a longer period. Late detection results in the failure of the entire system before the repair can be completed. The ability for the system to tolerate a failure, and still function normally or as close to normally as possible allows repairs to be completed in a reasonable amount of time without risking the failure of the complete system.

It would therefore be advantageous to provide a power supply system wherein the fault tolerance is increased without increasing the cost or complexity of the power supply system. It would be further advantageous if the cooling paths for such a power supply system were capable of tolerating a fan failure and provide at least a partial functionality of the power supply system while service is performed on the system.

### SUMMARY OF THE INVENTION

The present invention overcomes the disadvantages and limitations of the prior art by providing a device and method for cross ventilating multiple power supplies in the event of a failure of one of the fans of a single power supply. Should one fan fail, the system may have enough cooling capability to adequately cool the failed power supply for a period of time so that an operator may be able to replace the failed unit before a catastrophic failure. Further, the implementation of the present invention with multiple fans per power supply or more than two power supplies further improves the fault tolerance and uptime capability of the system.

The present invention may therefore comprise a method of keeping a plurality of power supplies for a continuously running system functioning in the event of a fan failure comprising: providing a plurality of power supplies wherein each of the power supplies comprises at least one fan, the power supplies being adapted such that a single power supply may be removed while keeping the continuously running system operational; providing a ventilation path wherein a fan in a first power supply may draw air from a second power supply in the event of a fan failure in the second power supply; monitoring the speed of the fan in the first power supply; monitoring the speed of the fan in the second power supply; comparing the speeds of the fans to a predetermined speed to determine a failure of a power supply; alerting an operator of the failed power supply; drawing air from the failed power supply through another power supply before the failed power supply is replaced; replacing the failed power supply, the replacement being performed by the operator; restoring the operation of the power supplies to normal.

The present invention may further comprise a power supply system for a continuously running system comprising: a plurality of power supplies, each of the power supplies having at least one fan, the power supplies being adapted such that the continuously running system can function with at least one of the power supplies disconnected; a connection system adapted such that a power supply may be removed while the continuously running system is operational; a monitoring system adapted to detect the speed of each of the fans of the power supplies; a control system capable of determining a failure by comparing the speed of each fan to a predetermined speed and further capable of alerting an operator of the failure; and a ventilation system adapted for airflow from a first of the power supplies to at least a second of the power supplies when at least one of the fans of the first of the power supplies has failed, the ventilation system sufficient to cool the first of the power supplies for a period of time sufficient for an operator to replace the first of the power while the continuously running system is operational.

The present invention may further comprise a power supply system for a continuously running system comprising: a plurality of power supplies, the power supplies having at least one fan, the fan being oriented to exhaust out of an exhaust side of the power supply, the power supplies having an inlet side being disposed on the side opposite of the exhaust side, the power supplies having at least one cross ventilation side being disposed between the exhaust side and the inlet side, the power supplies adapted such that the continuously running system may function with at least one of the power supplies removed; a chassis being adapted to hold the power supplies such that the cross ventilation side of a first power supply is in communication with the cross ventilation side of a second power supply and further adapted such that airflow may occur from the first power supply to the second power supply in the event of a fan failure of the first power supply; a control system adapted to monitor the speed of the fans and compare the speed of the fans to a predetermined speed to determine a fan failure, the control system further adapted to alert an operator to replace the power supply with a failed fan; and a connection system for the power supplies adapted to allow an operator to replace the power supply with the failed fan while the continuously running system is functioning.

The advantages of the present invention are that a fan failure in a power supply may be identified and replaced while a system is functioning. During the period of operation with a failed or partially functioning power supply, the power supplies may share cooling paths. This functionality allows smaller or fewer fans to be designed into a system, saving cost, size, and complexity to the power supply system.

### BRIEF DESCRIPTION OF THE DRAWINGS

In the drawings,

FIG. 1 is an illustration of an embodiment of the present invention wherein a replaceable power supply is installed into a chassis with a second, identical power supply.

FIG. 2 is a planar cross section view of the embodiment of FIG. 1 showing the airflow paths.

FIG. 3 is a planar cross section view similar to FIG. 2 illustrating one of the fans as failed.

FIG. 4 is an illustration of an embodiment of the present invention wherein two identical power supplies are mounted opposite each other such that they share a common vented side.

FIG. 5 is an illustration of an embodiment of the present invention wherein two power supplies are mirror images of each other and share a common vented side.

FIG. 6 is a flow diagram of an embodiment of a method of keeping a power supply system functioning through a fan failure.

FIG. 7 is a planar cross section of an embodiment of the present invention wherein a chassis contains three power supplies sharing the inventive cross ventilation technique.

FIG. 8 is a planar cross section of an embodiment of the present invention wherein chassis contains two power supplies, each power supply having two fans.

### DETAILED DESCRIPTION OF THE INVENTION

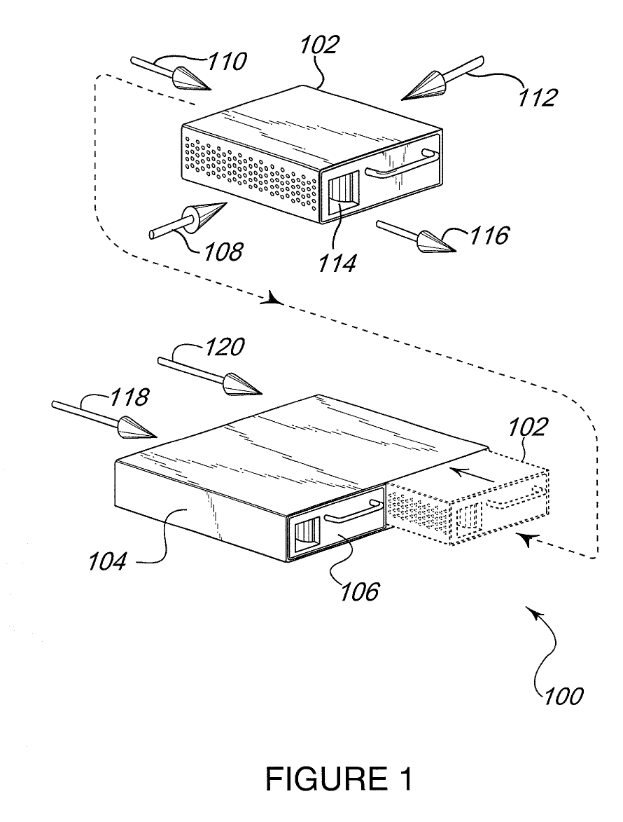

FIG. 1 illustrates an embodiment 100 of the present invention wherein a replaceable power supply 102 is installed into a chassis 104 with a second, identical power supply 106. The power supply 102 has ventilation holes on three sides of the box as indicated by the arrows 108, 110, and 112. A centrifugal fan 114 in the power supply evacuates the contents of the power supply box and exhausts in the direction of the arrow 116.

When the power supply 102 is placed into the chassis 104, airflow is blocked on the sides of the chassis, but allowed in the direction of arrows 118 and 120. The side ventilation of the power supplies, as indicated by arrows 108 and 112, allow lateral airflow communication between the power supplies 102 and 106. In the event of a failure of one of the fans of the power supplies, airflow from the power supply with the failed fan will flow through the power supply with the good fan. This concept will be illustrated in the following figures.

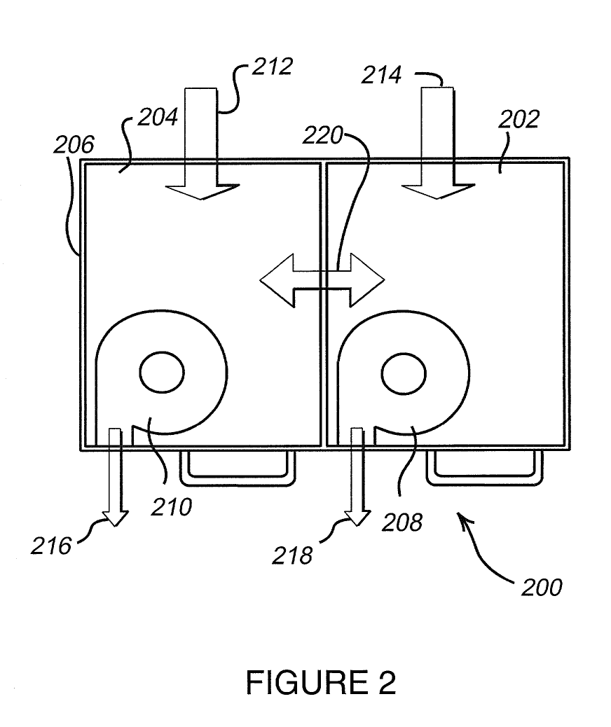

FIG. 2 illustrates a planar cross section view of embodiment 200 of the present invention showing the airflow paths. Power supplies 202 and 204 are placed inside chassis 206. Centrifugal fans 208 and 210 evacuate the power supplies 202 and 204 respectively. Arrows 212 and 214 represent the airflow as intake into the chassis 206 and by arrows 216 and 218 as exhaust. Arrow 220 represents the possible crossflow ventilation between the power supplies. FIG. 2 represents the normal configuration and function of the power supply chassis when all components are properly functioning.

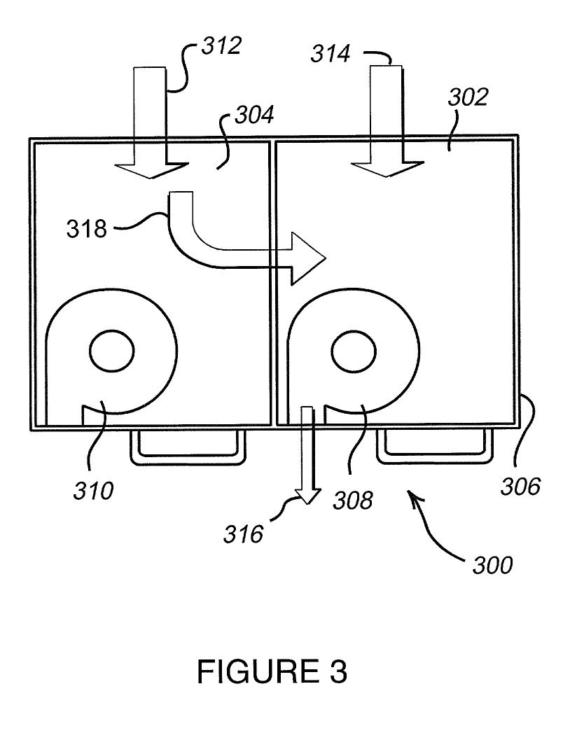

FIG. 3 illustrates a planar cross section view similar to FIG. 2 when one of the fans has failed. Power supplies 302 and 304 are placed into chassis 306. Centrifugal fans 308 and 310 are supposed to evacuate the power supplies 302 and 304, respectively, however fan 310 has failed. Air enters the chassis as illustrated by arrows 312 and 314 and is evacuated only through fan 308 as shown by arrow 316. The arrow 318 illustrates the cross ventilation from power supply 304 to 302.

When a fan in one power supply fails, the other fan of the other power supply may cool both power supplies sufficiently to keep both power supplies operating, at least for the period of time required for a service technician to replace the failed unit. In some cases, the power supplies may be capable of operating indefinitely with one fan disabled. In other cases, a disabled fan may need to be replaced within a specified period of time to ensure that one or both of the power supplies will not overheat and fail. In many cases, the entire power supply with the failed fan may be replaced, rather than the individual fan component.

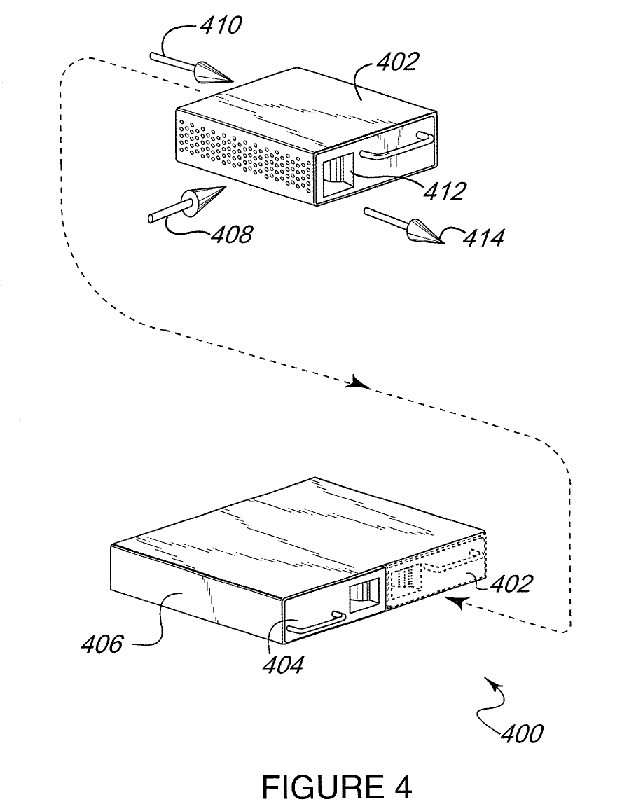

FIG. 4 illustrates an embodiment 400 of the present invention wherein two identical power supplies are mounted opposite each other such that they share a common vented side. Power supplies 402 and 404 are identical, however power supply 404 is mounted into a chassis 406 upside down with respect to power supply 402. Power supply 402 is vented in the rear and side as indicated by arrows 408 and 410. The centrifugal fan 412 exhausts the power supply as indicated by the arrow 414.

When the two power supplies 402 and 404 are installed as shown, a common vented side allows airflow laterally from one power supply to another in case one of the fans should fail.

In the embodiment 400, the chassis does not restrict the side airflow of the power supplies since outer sides of the power supplies are not perforated or vented. For the purposes of airflow, the chassis 406 does not have any effect. The power supplies 402 and 404 may be mounted without a chassis 406 as long as the power supplies 402 and 404 share the common side indicated by arrow 408. In this manner, the cross ventilation between the power supplies 402 and 404 exists in case of a fan failure.

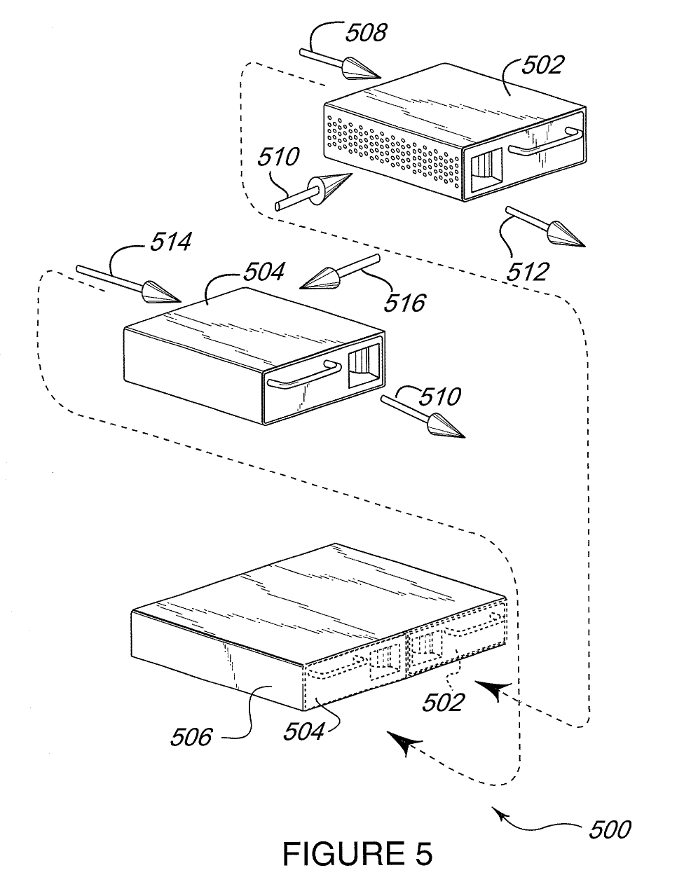

FIG. 5 illustrates an embodiment 500 of the present invention wherein two power supplies are mirror images of each other and share a common vented side. Right hand power supply 502 and left hand power supply 504 are mounted next to each other in an optional chassis 506. Right hand power supply 502 has vented sides that allow airflow in the direction of arrows 508 and 510, and a fan that exhausts in the direction of arrow 512. Left hand power supply 504 has vented sides that allow airflow in the direction of arrows 514 and 516, and a fan that exhausts in the direction of arrow 518.

In the embodiment 500, as with embodiment 400, the chassis does not restrict the airflow of the power supplies and in that manner does not affect the performance of the inventive cross ventilation during a fan failure.

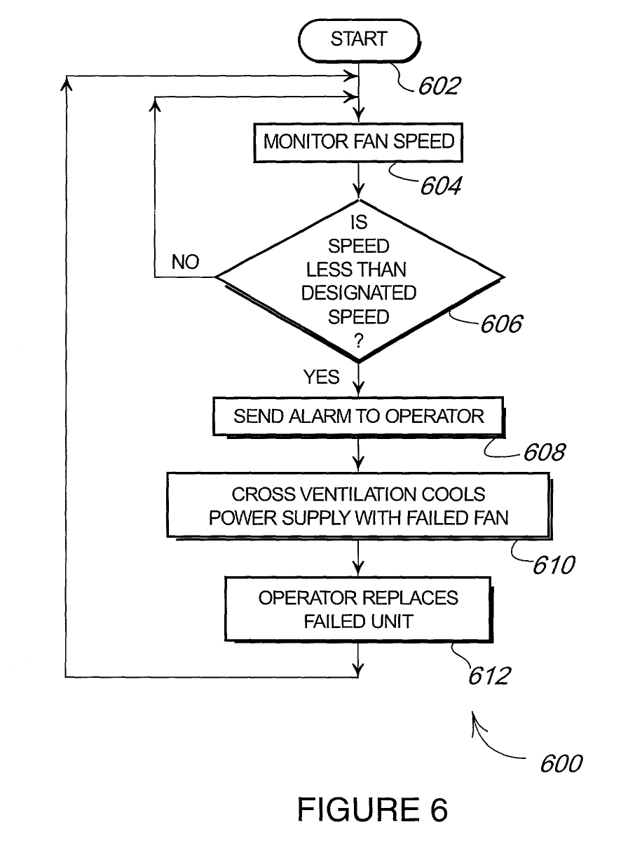

FIG. 6 illustrates an embodiment of a method 600 of keeping a power supply system functioning through a fan failure. When the process is started 602, the fan speeds are monitored 604 and compared to a designated speed 606. If the speed has fallen to below the designated speed, an alarm is triggered for an operator 608 and the inventive cross ventilation cools the power supply with a failed fan 610. After the operator replaces the failed unit 612, the process resumes with the fan monitoring 604.

The speed of a fan can be used as an indicator for an impending failure. The failure mechanisms for a fan generally relate to bearing failures. In the case of a bronze bushing bearing, galling of the bearings or other failure mechanisms will slowly lower the fan speed over time until the fan eventually seizes and stops. With ball bearing fans, the lubricant may disperse or leak out. As the lubricant is diminished, friction increases, raising the heat in the bearing and increasing friction, causing the fan to slow down.

As the speed of the fan decreases, the effectiveness of the fan to cool the power supply is lessened but not completely eliminated. The monitoring of the fan speed may allow a system to identify a component that needs to be replaced in enough time to have the service completed before a complete shutdown occurs.

The fan may be equipped with a tachometer monitor output. A monitor circuit may periodically monitor the tachometer monitor output and generate a signal to designate the speed of the fan. The monitor circuit may operate in an analog or digital fashion to generate the signal. Several different methods and circuits are commonly available to perform this function.

The output of the monitor circuit is compared to a designated speed in block 606. The designated speed may be 50% of the normal operating speed or some other designated speed. In some cases, if the failure modes of the fans cause the fans to stop functioning very quickly, the designated speed may be 75% of the normal operation speed. In other cases where the failure modes are slow, the designated speed may be less than 50%.

An alarm may be generated for an operator in block 608. The alarm may be in the form of a light, an audible alert, an email message, or any other form of communication that causes an operator to be dispatched to replace the failed power supply. The alarm may include an identifier of the specific failed power supply to aid the operator in identifying the failed unit.

During the alarm period, the inventive cross ventilation system allows one power supply with a properly running fan to assist in cooling a power supply with an improperly running fan in block 610. The power supply with the failed fan may be adequately cooled with a properly functioning fan in a neighboring power supply to function for an indefinite period of time. During the period where one fan is failing or has failed, both power supplies may function at a higher internal temperature than desired. An elevated temperature may raise the possibility for further failures of electrical and other components, therefore it is encouraged that the power supply with the failed fan be replaced as soon as possible.

The ability to have a neighboring power supply assist in cooling a power supply with a failed fan may allow the system to perform normal operation when a more severe failure would have occurred. For example, if the inventive cross ventilation were not present and a power supply fan was to fail, the power supply may quickly overheat. As the power supply overheats, the risk of failure of an electrical component due to insulation degradation, thermal expansion, or other thermal mechanisms increases substantially. As the temperature raises, the performance of certain components change. For example, resistor values change with temperature and capacitors have upper and lower thermal limits that frame their normal operation. Beyond their specified limits, the behavior of these components may be erratic and unpredictable. The risk of electrical fire rises during this period if the power supply is not turned off. The importance of detection of a failed fan and immediate response is more critical if the inventive cross ventilation system is not in place.

The power supplies generally handle equal amounts of the power needs. For example, if two power supplies are present in a system, they may be configured so that each power supply may be capable of driving the entire system alone. During operation with two power supplies, the load may be divided approximately 50% to each supply, such that if one were to fail, the other would be able to handle the increase in load from 50% to 100% quickly. If the loads were unbalanced, for example a ratio of 80/20 between the power supplies, and the supply with the highest load were to fail, the supply carrying the 20% load would be required to handle the instantaneous increase from 20% to 100% of the load. Such a scenario may lead to the power supply dropping out momentarily and causing a periodic brown out condition with the system.

The electrical load of the power supply with the failed fan may be adjusted. For example, when the degraded condition is detected, the circuitry that balances the power supply loads between several power supplies may be adjusted. The degraded unit may be adjusted so that it supplies a lower amount of power, thus lessening the cooling needs of the power supply. The power supply with the proper cooling may be better able to handle the power handling needs.

The operator replaces the failed unit in block 612. Typically, the operator may have a spare power supply immediately available and may be able to swap out a power supply within an hour. In some cases, a power supply might not be immediately available and two or three days may elapse before the failed unit may be replaced.

The replacement procedure for the failed power supply may involve merely pulling out the failed unit and sliding in a new unit. In other cases, the operator may indicate to a system controller that the swap is about to take place. In such a case, the controller may adjust the load between the power supplies so that the removal of the failed power supply does not cause any power droop when the failed unit is removed.

During the period that the failed unit is out of the chassis, the airflow patterns of the properly functioning power supply may be disturbed. For example, the resistance to the flow between the two power supplies may be decreased substantially when the neighboring failed power supply is removed. Thus, the failed power supply may be required to be left in place until the moment that a functioning replacement is immediately available for swapping. For the case when the failed power supply needs to be removed for an extended period of time, the cross ventilation airflow pattern may be adjusted. For example, an adjustable vent may be manually or automatically adjusted so that the resistance of the cross flow ventilation path is greater when the neighboring power supply is removed. In another example, a dummy power supply may be installed to block the cross flow ventilation path during the period when the failed power supply is removed.

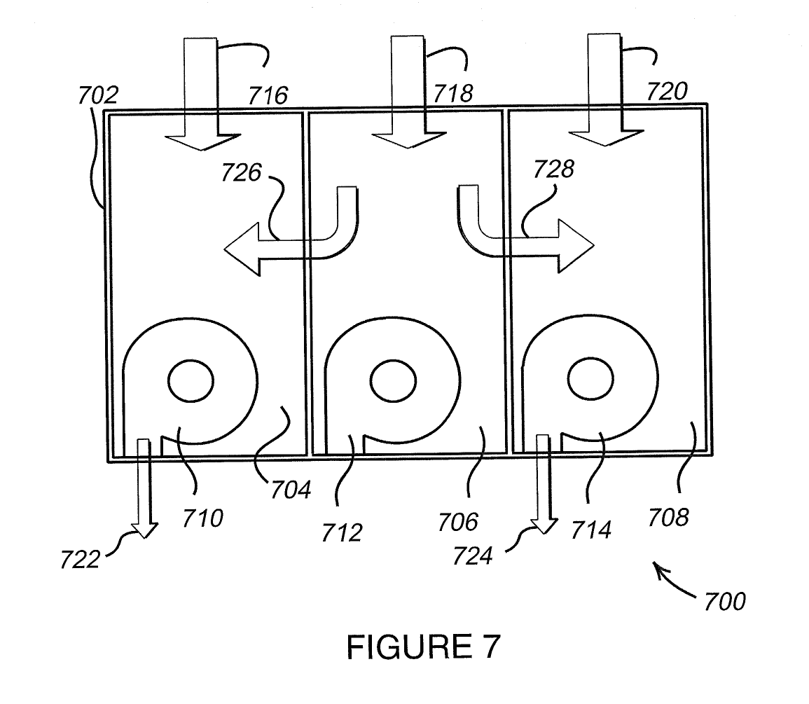

FIG. 7 illustrates an embodiment 700 of the present invention wherein a chassis 702 contains three power supplies 704, 706, and 708 share the inventive cross ventilation technique. Fans 710, 712, and 714 are mounted in power supplies 704, 706, and 708, respectively. Fan 712 is illustrated as non-functioning.

Arrows 716, 718, and 720 indicate the airflows into the respective power supplies while arrows 722 and 724 indicate the outflows. The inventive cross flow ventilation is indicated by arrows 726 and 728.

In the present figure, the central power supply 706 has a failed fan, but may still be functioning since the neighboring power supplies 704 and 708 have properly functioning fans. The airflow between the power supplies, as indicated by arrows 726 and 728, may be sufficient to cool the power supply 706 to the point where the power supply 706 may properly function, or function in a degraded mode, until such time that an operator may replace the failed supply 706.

The load sharing of the respective power supplies in the present embodiment may be approximately 33% for each power supply. If one power supply were to fail immediately, the remaining power supplies would have to increase their load to 50% immediately. The present embodiment may have the power supplies sized such that any one power supply may be capable of driving the entire system. In other embodiments, the power supplies may be sized such that two power supplies are required to meet the power requirements of the system. Such an embodiment may be capable of tolerating one power supply failure but not two simultaneous failures.

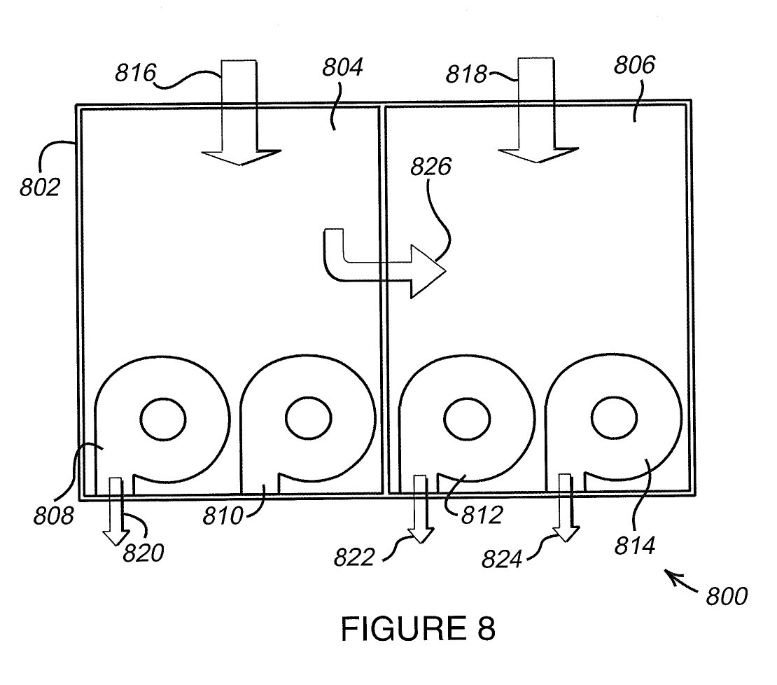

FIG. 8 illustrates an embodiment 800 of the present invention wherein chassis 802 contains two power supplies 804 and 806. Power supply 804 has two fans 808 and 810 and power supply 806 has two fans 812 and 814. In the present illustration, fan 810 of power supply 804 is illustrated as non-functioning.

Arrows 816 and 818 illustrate the inflow of air as arrows 820, 822, and 824 illustrate the outflow of air through the three functioning fans. Arrow 826 illustrates the inventive cross ventilation wherein some airflow from power supply 804 is extracted through the power supply 806.

The present embodiment 800 illustrates an example where multiple fans are present in each power supply. If one fan were to fail, another fan is present to allow the system to function either normally or in a degraded condition until the power supply with the failed fan can be replaced.

The cross ventilation between the power supplies enables the two power supplies to function in a slightly degraded capacity, but in a higher capacity than if the cross ventilation were not present. In general, the fans may be designed with a margin, such that the airflow produced by the fans may be greater than the actual capacity needed for normal cooling. If one fan were to fail as in the present figure, the excess margin designed into the remaining three fans may be sufficient to provide normal cooling to the entire system. If the inventive cross ventilation were not present, the fan 808 would be required to provide all of the cooling to power supply 804. In other words, to tolerate a single fan failure and function normally, fan 808 may need 100% margin. With the inventive cross ventilation in the present embodiment, the increased load is spread over three fans, meaning that the required margin is only 33% to ensure normal operation with one failed fan.

By lowering the margin required for the fan, a smaller fan may be sized for the power supplies while still maintaining the normal airflow and the system tolerance of one failed fan. Thus, smaller and lower cost fans may be used instead of larger, more expensive ones. The size difference may allow the case and chassis to become smaller and more compact that may be a distinct advantage in some applications. Further, the cost savings may result in higher profits or better price advantage.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of keeping a plurality of power supplies for a continuously running system functioning in the event of a fan failure comprising:
providing a plurality of power supplies wherein each of said power supplies comprises at least one fan, said power supplies being adapted such that a single power supply may be removed while keeping said continuously running system operational;
providing a ventilation path wherein a fan in a first power supply may draw air from a second power supply in the event of a fan failure in said second power supply;
monitoring the speed of said fan in said first power supply;
monitoring the speed of said fan in said second power supply;
comparing said speeds of said fans to a predetermined speed to determine a failure of a power supply;
alerting an operator of the failed power supply;
drawing air from said failed power supply through another power supply before said failed power supply is replaced;
replacing said failed power supply, said replacement being performed by said operator;
restoring the operation of said power supplies to normal.

2. The method of claim 1 wherein the number of power supplies is two.

3. The method of claim 1 wherein each of said power supplies comprises two fans.

4. The method of claim 1 wherein said detection comprises comparing said speed of said fan to a predetermined speed.

5. The method of claim 4 wherein said predetermined speed is approximately 50% of the normal operating speed of at least one of said fans.

6. The method of claim 1 wherein said step of drawing air further comprises:
adjusting the load of said power supplies such that said second power supply handles less load than any of the other of said plurality of power supplies.

7. A power supply system for a continuously running system comprising:
a plurality of power supplies, each of said power supplies having at least one fan, said power supplies being adapted such that said continuously running system can function with at least one of said power supplies disconnected;
a connection system adapted such that a power supply may be removed while said continuously running system is operational;
a monitoring system adapted to detect the speed of each of said fans of said power supplies;
a control system capable of determining a failure by comparing said speed of each fan to a predetermined speed and further capable of alerting an operator of said failure; and
a ventilation system adapted for airflow from a first of said power supplies to at least a second of said power supplies when at least one of said fans of said first of said power supplies has failed, said ventilation system sufficient to cool said first of said power supplies for a period of time sufficient for an operator to replace said first of said power while said continuously running system is operational.

8. The power supply system of claim 7 wherein the number of said power supplies is two.

9. The power supply system of claim 7 wherein the number of said power supplies is three.

10. The power supply system of claim 7 wherein the number of said fans is one.

11. A power supply system for a continuously running system comprising:
a plurality of power supplies, said power supplies having at least one fan, said fan being oriented to exhaust out of an exhaust side of said power supply, said power supplies having an inlet side being disposed on the side opposite of said exhaust side, said power supplies having at least one cross ventilation side being disposed between said exhaust side and said inlet side, said power supplies adapted such that said continuously running system may function with at least one of said power supplies removed;
a chassis being adapted to hold said power supplies such that said cross ventilation side of a first power supply is in communication with said cross ventilation side of a second power supply and further adapted such that airflow may occur from said first power supply to said second power supply in the event of a fan failure of said first power supply;
a control system adapted to monitor the speed of said fans and compare said speed of said fans to a predetermined speed to determine a fan failure, said control system further adapted to alert an operator to replace the power supply with a failed fan; and
a connection system for said power supplies adapted to allow an operator to replace said power supply with said failed fan while said continuously running system is functioning.

12. The power supply system of claim 11 wherein the number of said power supplies are two and said power supplies are identical.

13. The power supply system of claim 12 further comprising:
said power supplies having at least two of said cross ventilation sides being disposed on opposite sides of said power supply; and
said chassis being further adapted so that at least one of said cross ventilation sides of said power supplies is blocked when said power supplies are installed.

14. The power supply system of claim 12 further comprising:
said power supplies having one cross ventilation side; and
said chassis being further adapted so that one of said two power supplies are oriented in an inverted position such that the cross ventilation side of the first of said power supplies is in communication with the cross ventilation side of the second of said power supplies.
